(19) United States
(12) Patent Application Publication
(10) Pub. No.: US 2007/0187304 A1
(43) Pub. Date: Aug. 16, 2007

(54) Design of Screener Frame

(76) Inventors: Xi Zhao, Xlnxiang (CN); Limei Zhao, Columbia, SC (US)

Correspondence Address: Limei Zhao, 350 Powell Rd. #324, Columbia, SC, 29203, US

(21) Appl. No.: 11/691,006

(22) Filed: Mar. 26, 2007

(30) Foreign Application Priority Data
Nov. 4, 2005 (CN) ZL 200520032559.9

(51) Int. Cl. B07B 1/49

(52) U.S. Cl. 209/408; 209/405

(57) ABSTRACT

The patent proposes a new design of screener frame. It includes a round screener frame. There is protuberant component on the lower of screener frame to fix and connect with screener. There is protuberant sealing step on the upper of screener frame. At least one annular trough is in the middle of the screener frame ektexine and one lock-up ring for screen cloth installed in each annular trough. At the double end of lock-up ring, a special lock-up setting is connected. The new design has sealing step and annular trough in the upper and middle of screener frame ektexine. It tightens and fixes screener cloth on the frame with at least one lock-up ring. As a result, it not only has the advantage of handiness and economy, but also improves the speed to install and replace screener cloth. The most important is that the strain intensity of screener cloth has been greatly improved and accordingly the screener cloth is not easy to relax.

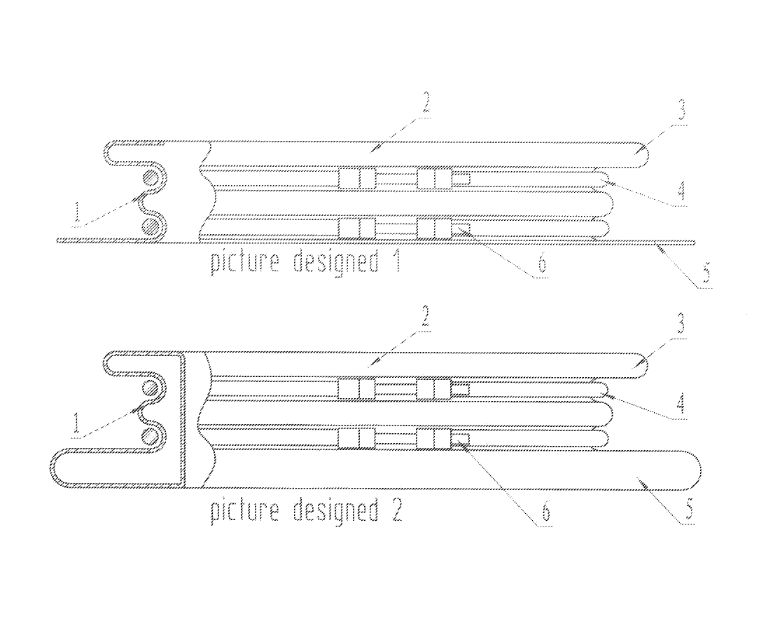

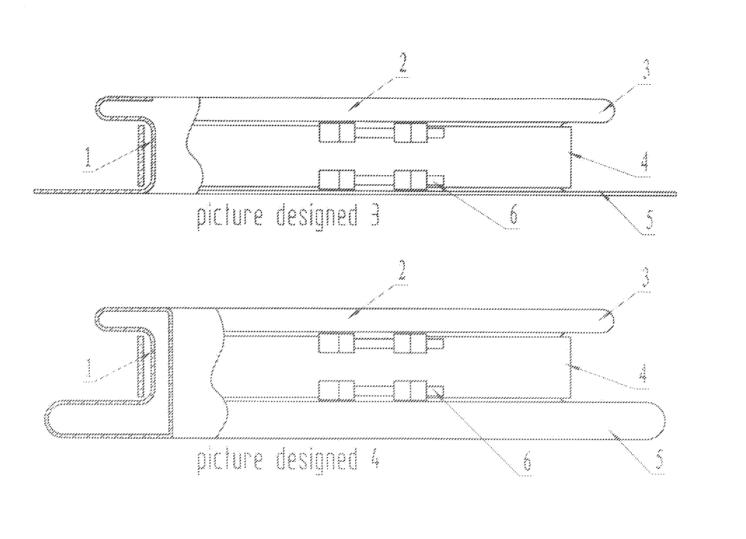

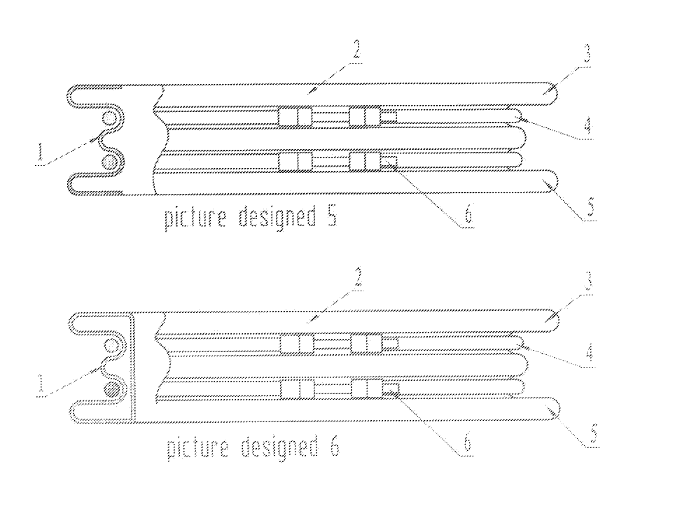

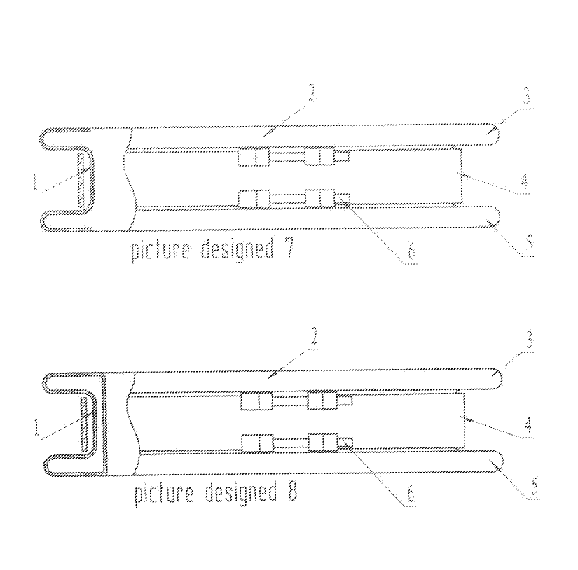

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The screener frame designed with new technology is for vibratory screening device. It is especially convenient and fast to install and replace screen cloth.

### BRIEF SUMMARY OF THE INVENTION

At present, there is a great variety of screener frames in separator. There are three types of configuration according to the diameter of screen cloth: unilateral screener frame, hollow screener frame, and solid screener frame. Unilaminar screen cloth or two-double screen cloth can be installed on separator. But their deficiency is that screener is easy to become relaxation after some time and difficult to recover, which greatly decreases the screening efficiency. The intention of this new technology is to design a screener frame which not only improves the speed to install and replace screen cloth but also can be recovered rapidly after relaxation and is not easy to flab.

### BRIEF DESCRIPTION OF THE SEVERAL VIEWS OF THE DRAWING

Picture designed 1. Sketch map of one configuration of the new technology design

Picture designed 2. Sketch map of another configuration of the new technology design

Picture designed 3. Sketch map of another configuration of the new technology design

Picture designed 4. Sketch map of another configuration of the new technology design

Picture designed 5. Sketch map of another configuration of the new technology design

Picture designed 6. Sketch map of another configuration of the new technology design

Picture designed 7. Sketch map of another configuration of the new technology design

Picture designed 8. Sketch map of another configuration of the new technology design

1. Annular trough; 2. Unilateral or hollow screener frame; 3. Sealing step; 4. Lock-up ring for screener cloth; 5. Screener frame; 6. Lock-up setting.

### DETAILED DESCRIPTION OF THE INVENTION

The approach of the new design is as follows. One sort of screener frames, including unilateral or hollow of screener frames, has been designed with locking trough. The specialties are:
1. There is protuberant sealing step on the upper of unilateral or hollow of screener frame.
2. There are at least one annular trough in the middle of the screener frame ektexine and one lock-up ring for screen cloth installed in each annular trough.
3. At the double end of lock-up ring, a special lock-up setting is connected. The new design has sealing step and annular trough in the upper and middle of screener frame ektexine. It tightens and fixes screener cloth on the frame with at least one lock-up ring. As a result, it not only has the advantage of handiness and economy, but also improves the speed to install and replace screener cloth. The most important is that the strain intensity of screener cloth has been greatly improved and accordingly the screener cloth is not easy to relax.
   Implementation:

The implementation of the new technology is presented in detail in the following section, together with the Drawings:

Picture designed 1: There is a circle of outward sealing step (3) designed on the upside of the outer of unilateral screener frame(2), a circle of protuberant base of screener frame designed in the lower lateral wall of the unilateral screener frame (2), in the middle of which there are two annular troughs(1). A lock-up ring (4) for screen cloth is set up in each annular trough. Lock-up setting (6) is connected at the double ends of lock-up ring(4), Screw and nut, lock and clasp, or other kinds of connector that can be used as lock-up setting, which should be locked, and disentangled easily and quickly.

Picture designed 2 is design sketch map for hollow screener frame. Design is identical with that in Picture designed 1.

Picture designed 3 is design sketch map for unilateral screener frame. There is an annular trough designed in the middle of the outer of the unilateral screener frame. The width of the annular trough can be increased and the lock-up ring for screen cloth also should be widened accordingly.

Picture designed 4 is design sketch map for hollow screener frame. Design is identical with that in Picture designed 3.

Picture designed 5 is design sketch map for unilateral screener frame. The lower base of the screener frame is the same as the upper protuberant sealing step. The other part of the design is identical with that in Picture designed 1.

Picture designed 6 is design sketch map for hollow screener frame. Design is identical with that in Picture designed 5.

Picture designed 7 is design sketch map for unilateral screener frame with an annular trough designed at the outer.

Picture designed 8 is design sketch map for hollow screener frame with an annular trough designed at the outer.

The screener frame designed with this new technology applies to all kinds of circular and elliptical sieving device.

What is claimed is:

1. There is protuberant sealing step on the upper of unilateral or hollow of screener frame.

2. There is at least one annular trough in the middle of the screener frame ektexine.

3. Lock-up ring for screen cloth is installed in each annular trough of claim 2.

4. At the double end of lock-up ring of claim 3, a special lock-up setting is connected.

5. Screener cloth on the frame of claim 1, is tightened and fixed with at least one lock-up ring of claim 3.
